(19) United States
(12) Patent Application Publication
(10) Pub. No.: US 2014/0297821 A1
(43) Pub. Date: Oct. 2, 2014

(54) SYSTEM AND METHOD PROVIDING LEARNING CORRELATION OF EVENT DATA

(71) Applicant: VYACHESLAV LVIN, Mountain View, CA (US)

(72) Inventor: VYACHESLAV LVIN, Mountain View, CA (US)

(73) Assignee: ALCATEL-LUCENT USA INC., Murray Hill, NJ (US)

(21) Appl. No.: 13/851,700

(22) Filed: Mar. 27, 2013

(51) Int. Cl. H04L 12/24

(52) U.S. Cl. CPC H04L 41/0631
USPC 709/223

(57) ABSTRACT

Systems, methods, architectures and/or apparatus for implementing an event correlation function in which a correlation window (CW) utilized therefor is dynamically adapted in response to changes in average correlation distance (CD) as indicated by unambiguous event pair occurrences.

### FIELD OF THE INVENTION

The invention relates to the field of network and data center management and, more particularly but not exclusively, to management of event data in networks, data centers and the like.

### BACKGROUND

Data Center (DC) architecture generally consists of a large number of compute and storage resources that are interconnected through a scalable Layer-2 or Layer-3 infrastructure. In addition to this networking infrastructure running on hardware devices the DC network includes software networking components (vswitches) running on general purpose compute, and dedicated hardware appliances that supply specific network services such as load balancers, ADCs, firewalls, IPS/IDS systems etc. The DC infrastructure can be owned by an Enterprise or by a service provider (referred as Cloud Service Provider or CSP), and shared by a number of tenants. Compute and storage infrastructure are virtualized in order to allow different tenants to share the same resources. Each tenant can dynamically add/remove resources from the global pool to/from its individual service.

Within the context of a typical data center arrangement, a tenant entity such as a bank or other entity has provisioned for it a number of virtual machines (VMs) which are accessed via a Wide Area Network (WAN) using Border Gateway Protocol (BGP). At the same time, thousands of other virtual machines may be provisioned for hundreds or thousands of other tenants. The scale associated data center may be enormous. Thousands of virtual machines may be created and/or destroyed each day per tenant demand. When a tenant has a problem with one of its virtual machines, the tenant will want to understand the problem, who or what might be responsible for the problem and so on. The tenant needs to get information from the data center operator as to why the tenant's VM had a problem so that the tenant and/or data center operator may take corrective steps.

### SUMMARY

Various deficiencies in the prior art are addressed by systems, methods, architectures, mechanisms and/or apparatus implementing an event correlation function in which a correlation window (CW) utilized therefor is dynamically adapted in response to changes in average correlation distance (CD) as indicated by unambiguous event pair occurrences.

A method for event correlation according to one embodiment comprises: in response to an event correlation request indicative of an event of interest, examining event log information within a correlation window (CW) to identify one or more events correlated with the event of interest; and in response to an occurrence of an unambiguous event pair, updating the CW using correlation distance (CD) information associated with the unambiguous event pair.

### BRIEF DESCRIPTION OF THE DRAWINGS

The teachings herein can be readily understood by considering the following detailed description in conjunction with the accompanying drawings, in which:

FIG. 1 depicts a high-level block diagram of a system benefiting from various embodiments;

FIG. 2 depicts an exemplary management system suitable for use as the management system of FIG. 1;

FIGS. 3-4 depict flow diagrams of methods according to various embodiments; and

FIG. 5 depicts a high-level block diagram of a computing device suitable for use in performing the functions described herein.

To facilitate understanding, identical reference numerals have been used, where possible, to designate identical elements that are common to the figures.

### DETAILED DESCRIPTION OF THE INVENTION

The invention will be discussed within the context of systems, methods, architectures, mechanisms and/or apparatus adapted to correlate virtual machine (VM) events and Border Gateway Protocol (BGP) events associated with various network and/or computing resources such as at a data center (DC). However, it will be appreciated by those skilled in the art that the invention has broader applicability than described herein with respect to the various embodiments.

Virtualized services as discussed herein generally describe any type of virtualized compute and/or storage resources capable of being provided to a tenant. Moreover, virtualized services also include access to non-virtual appliances or other devices using virtualized compute/storage resources, data center network infrastructure and so on. The various embodiments are adapted to improve event-related processing within the context of data centers, networks and the like. The various embodiments advantageously improve such processing even as problems due to the nature of virtual machines, mixed virtual and real provisioning of VMs and the like make such processing more complex. Moreover, as data center sizes scale up the resources necessary to perform such correlation become enormous and the process cannot be handled in an efficient manner.

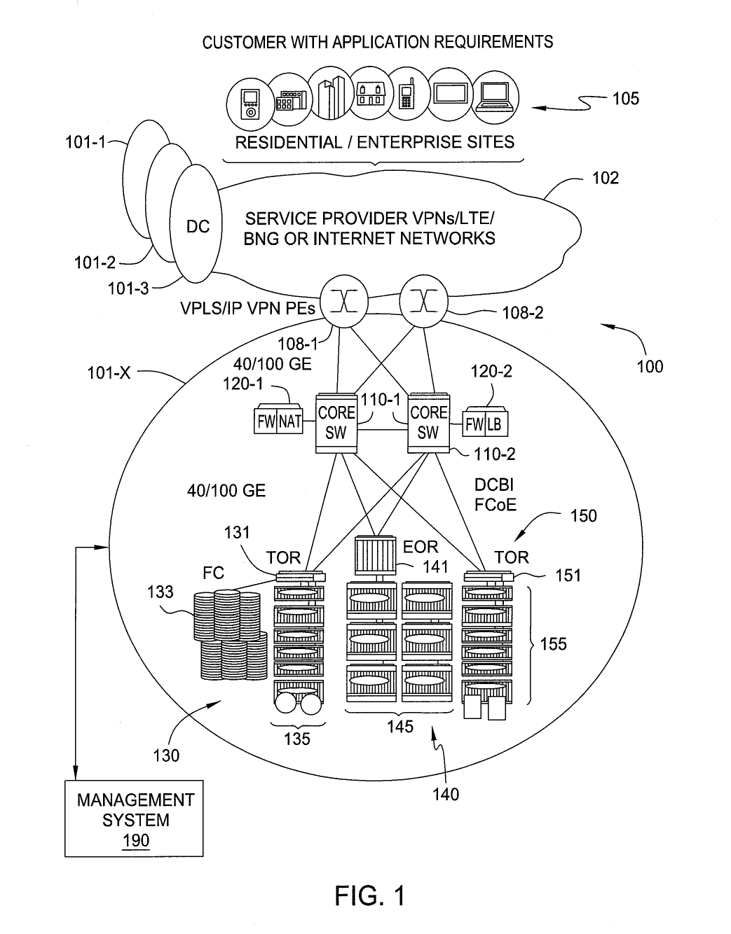

FIG. 1 depicts a high-level block diagram of a system benefiting from various embodiments. Specifically, FIG. 1 depicts a system 100 comprising a plurality of data centers (DC) 101-1 through 101-X (collectively data centers 101) operative to provide compute and storage resources to numerous customers having application requirements at residential and/or enterprise sites 105 via one or more networks 102.

The customers having application requirements at residential and/or enterprise sites 105 interact with the network 102 via any standard wireless or wireline access networks to enable local client devices (e.g., computers, mobile devices, set-top boxes (STBs), storage area network components, Customer Edge (CE) routers, access points and the like) to access virtualized compute and storage resources at one or more of the data centers 101.

The networks 102 may comprise any of a plurality of available access network and/or core network topologies and protocols, alone or in any combination, such as Virtual Private Networks (VPNs), Long Term Evolution (LTE), Border Network Gateway (BNG), Internet networks and the like.

The various embodiments will generally be described within the context of IP networks enabling communication between provider edge (PE) nodes 108. Each of the PE nodes 108 may support multiple data centers 101. That is, the two PE nodes 108-1 and 108-2 depicted in FIG. 1 as communicating between networks 102 and DC 101-X may also be used to support a plurality of other data centers 101.

The data center 101 (illustratively DC 101-X) is depicted as comprising a plurality of core switches 110, a plurality of service appliances 120, a first resource cluster 130, a second resource cluster 140, and a third resource cluster 150.

Each of, illustratively, two PE nodes 108-1 and 108-2 is connected to each of the, illustratively, two core switches 110-1 and 110-2. More or fewer PE nodes 108 and/or core switches 110 may be used; redundant or backup capability is typically desired. The PE routers 108 interconnect the DC 101 with the networks 102 and, thereby, other DCs 101 and end-users 105. The DC 101 is generally organized in cells, where each cell can support thousands of servers and virtual machines.

Each of the core switches 110-1 and 110-2 is associated with a respective (optional) service appliance 120-1 and 120-2. The service appliances 120 are used to provide higher layer networking functions such as providing firewalls, performing load balancing tasks and so on.

The resource clusters 130-150 are depicted as compute and/or storage resources organized as racks of servers implemented either by multi-server blade chassis or individual servers. Each rack holds a number of servers (depending on the architecture), and each server can support a number of processors. A set of network connections connect the servers with either a Top-of-Rack (ToR) or End-of-Rack (EoR) switch. While only three resource clusters 130-150 are shown herein, hundreds or thousands of resource clusters may be used. Moreover, the configuration of the depicted resource clusters is for illustrative purposes only; many more and varied resource cluster configurations are known to those skilled in the art. In addition, specific (i.e., non-clustered) resources may also be used to provide compute and/or storage resources within the context of DC 101.

Exemplary resource cluster 130 is depicted as including a ToR switch 131 in communication with a mass storage device(s) or storage area network (SAN) 133, as well as a plurality of server blades 135 adapted to support, illustratively, virtual machines (VMs). Exemplary resource cluster 140 is depicted as including an EoR switch 141 in communication with a plurality of discrete servers 145. Exemplary resource cluster 150 is depicted as including a ToR switch 151 in communication with a plurality of virtual switches 155 adapted to support, illustratively, the VM-based appliances.

In various embodiments, the ToR/EoR switches are connected directly to the PE routers 108. In various embodiments, the core or aggregation switches 120 are used to connect the ToR/EoR switches to the PE routers 108. In various embodiments, the core or aggregation switches 120 are used to interconnect the ToR/EoR switches. In various embodiments, direct connections may be made between some or all of the ToR/EoR switches.

A VirtualSwitch Control Module (VCM) running in the ToR switch gathers connectivity, routing, reachability and other control plane information from other routers and network elements inside and outside the DC. The VCM may run also on a VM located in a regular server. The VCM then programs each of the virtual switches with the specific routing information relevant to the virtual machines (VMs) associated with that virtual switch. This programming may be performed by updating L2 and/or L3 forwarding tables or other data structures within the virtual switches. In this manner, traffic received at a virtual switch is propagated from a virtual switch toward an appropriate next hop over a tunnel between the source hypervisor and destination hypervisor using an IP tunnel. The ToR switch performs just tunnel forwarding without being aware of the service addressing.

Generally speaking, the “end-users/customer edge equivalents” for the internal DC network comprise either VM or server blade hosts, service appliances and/or storage areas. Similarly, the data center gateway devices (e.g., PE servers 108) offer connectivity to the outside world; namely, Internet, VPNs (IP VPNs/VPLS/VPWS), other DC locations, Enterprise private network or (residential) subscriber deployments (BNG, Wireless (LTE etc), Cable) and so on.

In addition to the various elements and functions described above, the system 100 of FIG. 1 further includes a Management System (MS) 190. The MS 190 is adapted to support various management functions associated with the data center or, more generically, telecommunication network or computer network resources. The MS 190 is adapted to communicate with various portions of the system 100, such as one or more of the data centers 101. The MS 190 may also be adapted to communicate with other operations support systems (e.g., Element Management Systems (EMSs), Topology Management Systems (TMSs), and the like, as well as various combinations thereof).

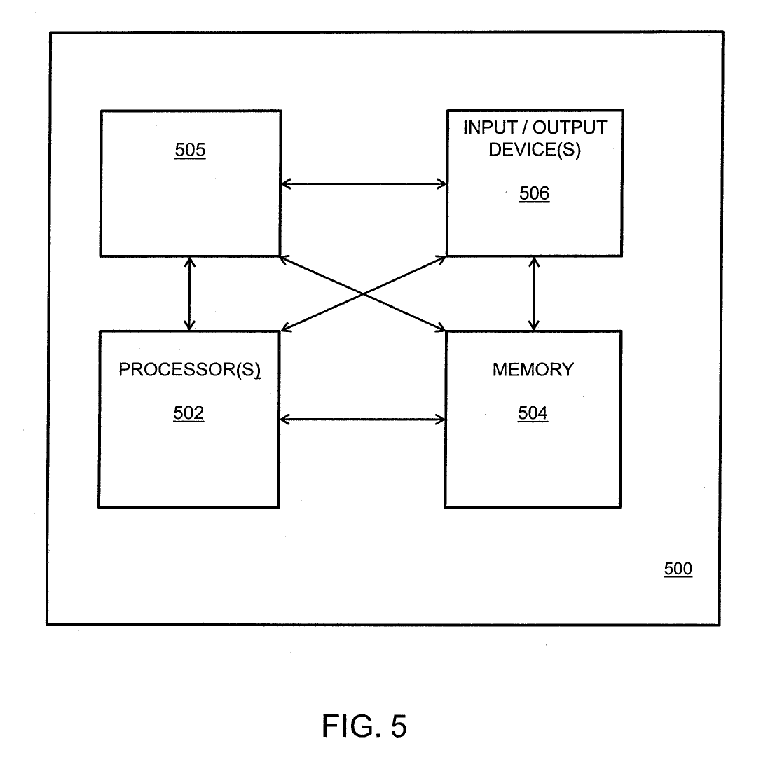

The MS 190 may be implemented at a network node, network operations center (NOC) or any other location capable of communication with the relevant portion of the system 100, such as a specific data center 101 and various elements related thereto. The MS 190 may be implemented as a general purpose computing device or specific purpose computing device, such as described below with respect to FIG. 5.

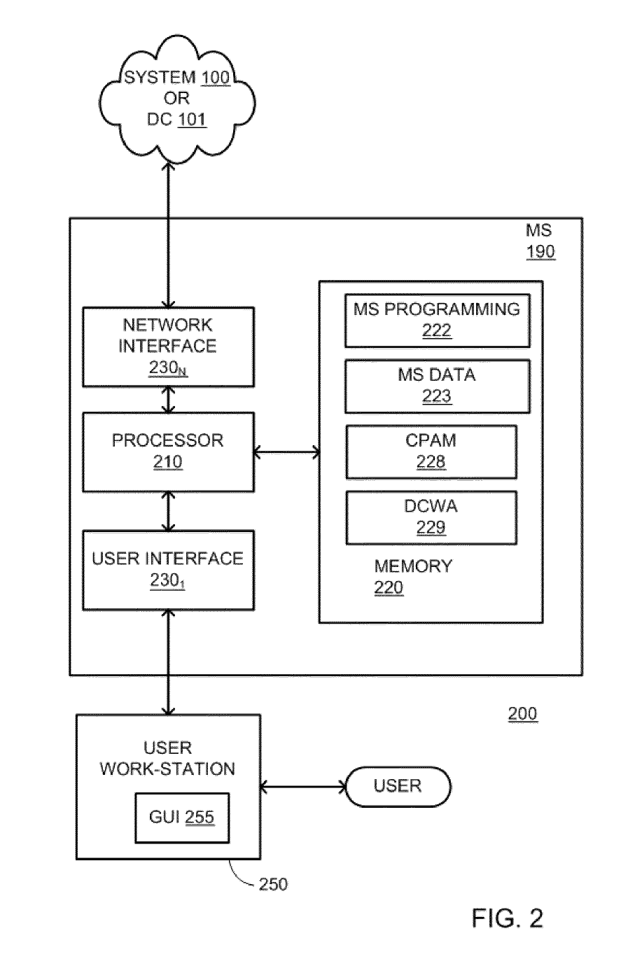

FIG. 2 depicts an exemplary management system suitable for use as the management system of FIG. 1. As depicted in FIG. 2, MS 190 includes one or more processor(s) 210, a memory 220, a network interface 230N, and a user interface 230I. The processor(s) 210 is coupled to each of the memory 220, the network interface 230N, and the user interface 230I.

The processor(s) 210 is adapted to cooperate with the memory 220, the network interface 230N, the user interface 230I, and the support circuits 240 to provide various management functions for a data center 101 and/or the system 100 of FIG. 1.

The memory 220, generally speaking, stores programs, data, tools and the like that are adapted for use in providing various management functions for the data center 101 and/or the system 100 of FIG. 1.

The memory 220 includes various management system (MS) programming modules 222 and MS databases 223 adapted to implement network management functionality such as discovering and maintaining network topology, processing VM related requests (e.g., instantiating, destroying, migrating and so on) and the like.

The memory 220 includes a Control Plane Assurance Manager (CPAM) 228 operable to respond to tenant inquiries pertaining to quality problems and the like, as well as a Dynamic Correlation Window Adjuster (DCWA) 229 operable to adjust a correlation window used by the CPAM.

In one embodiment, the MS programming module 222, CPAM 228 and DCWA 229 are implemented using software instructions which may be executed by a processor (e.g., processor(s) 210) for performing the various management functions depicted and described herein.

The network interface 230N is adapted to facilitate communications with various network elements, nodes and other entities within the system 100, DC 101 or other network to support the management functions performed by MS 190.

The user interface 230I is adapted to facilitate communications with one or more user workstations (illustratively, user workstation 250), for enabling one or more users to perform management functions for the system 100, DC 101 or other network.

As described herein, memory 220 includes the MS programming module 222, MS databases 223, CPAM 228 and DCWA 229 which cooperate to provide the various functions depicted and described herein. Although primarily depicted and described herein with respect to specific functions being performed by and/or using specific ones of the engines and/or databases of memory 220, it will be appreciated that any of the management functions depicted and described herein may be performed by and/or using any one or more of the engines and/or databases of memory 220.

The MS programming 222 adapts the operation of the MS 140 to manage various network elements, DC elements and the like such as described above with respect to FIG. 1, as well as various other network elements (not shown) and/or various communication links therebetween. The MS databases 223 are used to store topology data, network element data, service related data, VM related data, BGP related data and any other data related to the operation of the Management System 190. The MS program 222 may implement various service aware manager (SAM) or network manager functions.

Event Correlation

Each VM is associated with an event log. The event log generally includes data fields providing, for each event, (1) a timestamp, (2) the VM IP address and (3) an event type indicator. VM events may comprise UP, DOWN, SUSPEND, STOP, CRASH, DESTROY, CREATE and so on.

Each BGP instance is associated with an event log. The BGP event log generally includes data fields providing, for each event, (1) a timestamp, (2) the BGP address or identifier and (3) an event type indicator. BGP events may comprise New Prefix, Prefix withdrawn, Prefix Unreachable, Prefix Redundancy Changed and so on.

Generally speaking, a VM root event typically precedes a correlated BGP event. The amount of time between the two correlated events varies depending upon network resource utilization, network provisioning, status of network components and the like. In essence, the time between correlated VM/BGP events can be quite variable in response to network conditions.

The Control Plane Assurance Manager (CPAM) 228 correlates VM events and BGP events to help determine what happened with VM to cause a particular BGP failure, why it happened and so on. By correlating such events, the data center owner or tenant may more accurately assess the various causes of degraded or failed VMs, appliances connected via VMs and the like. Moreover, various debugging, correction, reprovisioning and other operations may be performed in response to determining a correlation between a root event (or several route events) and a correlated event (or several correlated events).

The CPAM 228 utilizes a correlation window to reduce the problem space associated with a particular VM/BGP event correlation. The CPAM 228 restricts the correlation operation to event logs (or portions thereof) within a time interval likely to provide a correlation between a root event and a correlated event. By using a correlation window to process event logs in a time-bounded manner, the CPAM 228 advantageously reduces the amount of processing, memory and other resources necessary to perform such correlations.

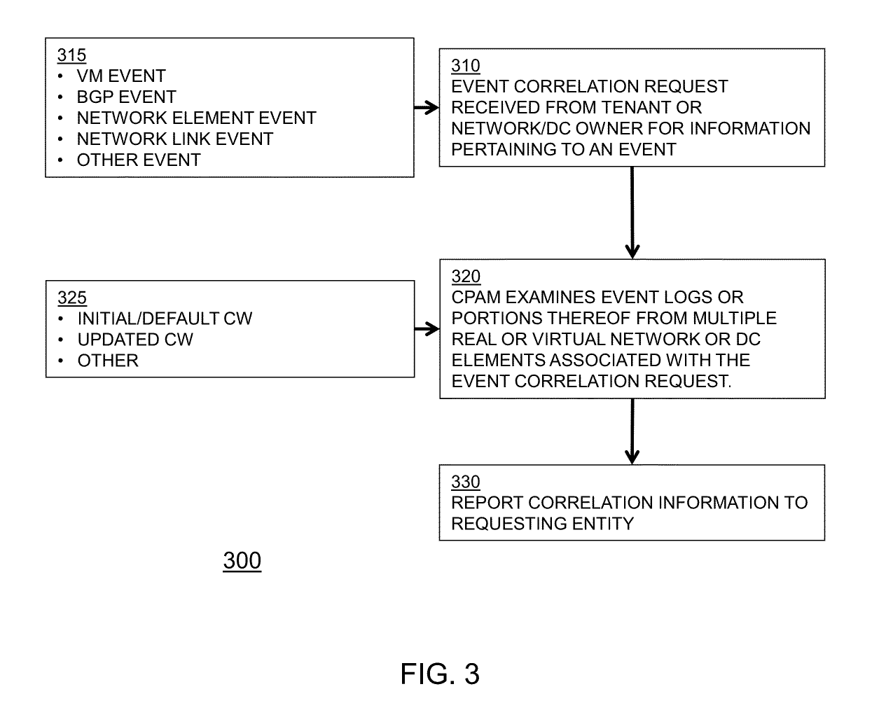

FIG. 3 depicts a flow diagram of a method according to one embodiment. Specifically, the method 300 of FIG. 3 contemplates various steps performed by, illustratively, the CPAM 228.

At step 310, the CPAM 228 receives an event correlation request from a DC tenant, DC owner, network owner, system operator or other entity. Referring to box 315, the event correlation request may pertain to a specific VM event, BGP event, network element event, network link event or some other event.

At step 320, the CPAM 228 examines event logs or portions thereof from multiple real or virtual network or DC elements associated with the event correlation request. Referring to box 325, an initial or default correlation window (CW) may be used, and updated CW may be used, or some other CW may be used. In various embodiments, the updated CW is provided or made available to the CPAM 228 by the DCWA 229.

At step 330, the CPA reports the requested correlation information to the requesting DC tenant, DC owner, network owner, system operator or other entity.

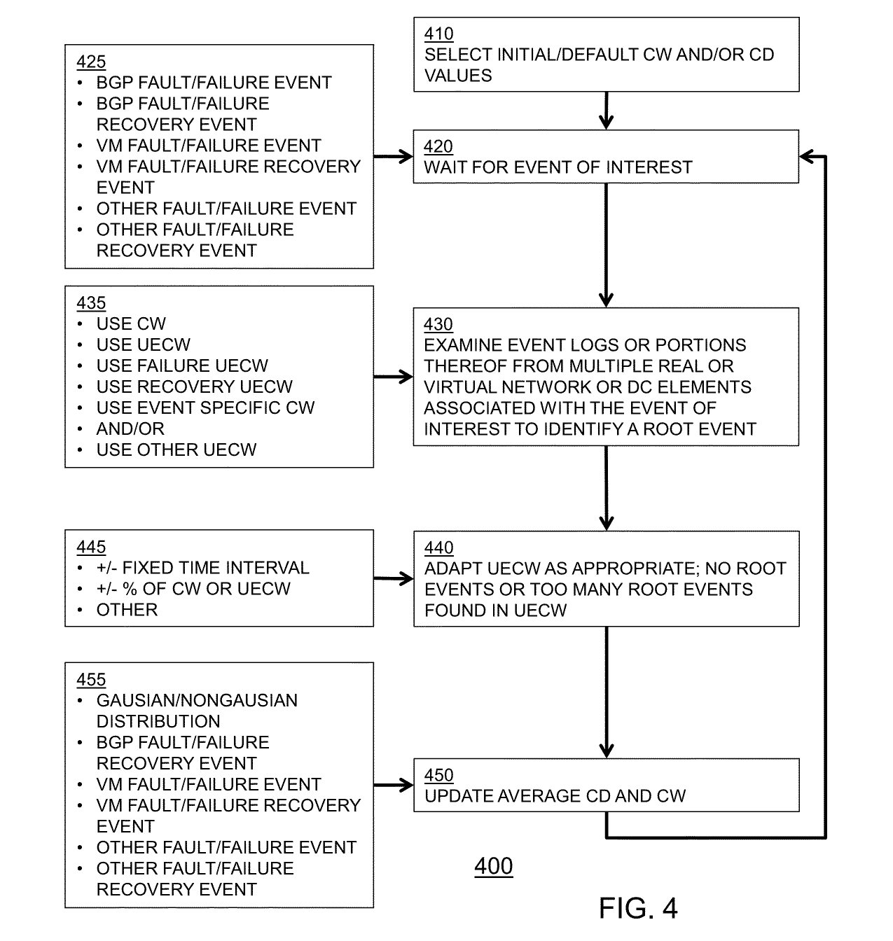

Thus, in response to an event correlation request indicative of an event of interest, the CPAM 228 examines event log information within a correlation window (CW) to identify one or more events correlated with said event of interest. As will be discussed in more detail below with respect to FIG. 4, the CW is dynamically adjusted by the DCWA 229 event pair.

Specifically, the DCWA 229 operates to improve the correlation function of the CPAM 228 by dynamically adjusting a period of time defined herein as a correlation window (CW) within which a correlated VM/BGP event pair exists. If more than one VM event may be correlated to a BGP event, or if more than one BGP event may be correlated to a VM event, then the automatic correlation becomes ambiguous and cannot be used. In various embodiments, the CPAM 228 provides multiple root cause events to the user or requestor for examination. This set of provided results is still smaller than an unprocessed set of events. While some ambiguous correlation is inevitable, reducing the amount of ambiguous correlation is desirable to improve debugging information and generally identify the specific problems noted by a tenant.

For example, assume that the time around a failure or poor performance event comprises, illustratively, 10 seconds prior to and/or after an event. However, the actual time between two correlated events may be much less than 10 seconds and root cause event logged prior to symptom event for the current network topology. It should be noted that in this example 10 sec is a default CW; the various embodiments generally do not provide data outside of the CW, however, a default CW large enough to account for all cases may be used. Optionally, the CW may be adapted as described below with respect to FIG. 4.

For purposes of this discussion, a Correlation Window (CW) is defined as the time interval relative to a root event where correlated event most likely shall be found, while a Correlation Distance (CD) is defined as the time between two correlated events. Different CW definitions are used within the context of different embodiments, such as by using various statistical techniques.

In some embodiments, the CW is defined as an Average CD±a CD Standard Deviation. The average CD may be defined with respect to all of the events logged, some of the events logged, a predefined number of logged events, the logged events in a predefined period of time and so on. In essence, an average, rolling average or other sample of recent log events is used.

The CD Standard Deviation may be calculated using the VM/BGP event log data. The standard deviation may contemplate a Gaussian distribution or any other distribution.

Thus, a VM event may be correlated with a later occurring BGP event within a correlation window or interval such as defined below with respect to equation 1:

CW_{VM}=+Average CD±one CD Standard Deviation (eq. 1)

Similarly, a BGP event will be correlated with an earlier occurring VM event within a correlation window or interval such as defined below with respect to equation 2:

CW_{BGP}=−Average CD±one CD Standard Deviation (eq. 2)

In various embodiments, either of the above correlation windows may be defined in terms of more than one standard deviation (i.e., 2 or 3 CD Standard Deviations).

While generally described within the context of statistical averaging using Gaussian distributions, other statistical mechanisms may be used instead of, in addition to, or in any combination, including weighted average, rolling average, various projections, Gaussian distribution, non-Gaussian distribution, post processed results according to Gaussian or non-Gaussian distributions or standard deviations and so on.

FIG. 4 depicts a flow diagram of a method according to one embodiment. Specifically, the method 400 of FIG. 4 contemplates various steps performed by, illustratively, the DCWA 229.

At step 410, the DCWA 229 begins operation by selecting initial/default CW and/or CD values for use by the CPAM 228. That is, an initial or default value for use as the correlation window (e.g., ±10 seconds) and/or the correlation distance (e.g., 5 seconds) is selected for use by the CPAM 228.

At step 420, the DCWA 229 waits for the occurrence of an event of interest. Referring to box 425, an event of interest may comprise one or more of a BGP fault/failure event (i.e., not a warning or status update), a BGP fault/failure recovery event, a VM fault/failure event, a VM fault/failure recovery event, or some other type of fault/failure event or recovery therefrom.

At step 430, event logs or portions thereof associated with a specific time interval from multiple real or virtual network or DC elements associated with the event of interest are examined to identify thereby a potential or candidate root event or events. In the event of a single candidate root event, the event of interest is correlated with the single root event to provide thereby an unambiguous event pair. The amount of time between the event of interest and root event is determined as the correlation distance (CD) of the unambiguous event pair.

In various embodiments, multiple root events may be utilized in an average or otherwise statistically significant manner where either of the root events may in fact be a proximate cause of the event of interest.

A BGP fault event may comprise an error or fail condition, or a recovery from an error or fail condition. However, the CD associated with a fault event may be different than the CD associated with a fault recovery event. That is, the time between a BGP fault and a VM fault may be shorter than the time between a BGP recovery and a corresponding VM recovery (due to provisioning factors, congestion or other factors). As such, various embodiments utilize an Unambiguous Event Correlation Window (UECW) to define the specific time interval within which to look for a root event.

Referring to box 435, the specific time interval within which a root event is to be identified may comprise the correlation window (CW) as described above, or a specific window selected for root event identification purposes; namely, the UECW. Moreover, multiple UECWs may be used depending on the type of event of interest, such as a failure event UECW, a recovery event UECW, and event specific UECW and/or some other type of UECW.

At step 440, the UECW is adapted as appropriate such as when no root event is discovered or too many root events are discovered within time interval defined by the UECW. Referring to box 445, the UECW may be increased or decreased by a fixed interval, a percentage of the CW or UECW, or via some other means.

As an example, upon the occurrence of a BGP root event (or other root event), the DCWA 229 (or CPAM 228) examines the relevant time interval (correlation window), or an unambiguous event correlation window (UECW) slightly bigger than the CW (e.g., +5%, +10%, +20% and so on) to identify a single corresponding VM event.

In various embodiments, if the UECW tends to provide ambiguous results (i.e., multiple potential correlated pairs), then the window is slightly decreased, while if the UECW tends to provide no results (i.e., no potential correlated pairs), then the window is slightly increased. This increase may be provided as an amount of time, a percentage of window size and so on. This incremental increase/decrease in UECW is provided automatically by the DCWA 229, CPAM 228 or other entity adapted to identify unambiguous event pairs.

Thus, multiple UECWs may be used depending upon the type of root event (BGP failure, BGP recovery, VM failure, VM recovery, other event type failure and/or other event type recovery). Some or all of the UECWs may be used. Some or all of the used UECWs may be adapted by increasing or decreasing their duration as described below, while others may be of fixed duration, adapted differently, adapted less frequently, adapted using larger or smaller increments of time or percentage and so on.

At step 450, the correlation distance CD associated with the unambiguous event pair is used to recalculate/update an Average CD and recalculate the CW window used by the CPAM 228, such as described above with respect to equations 1-2. In various other embodiments, statistical averaging using Gaussian and non-Gaussian distributions, as well as other statistical mechanisms may be used instead of, in addition to, or in any combination with the above-described mechanisms, including weighted average, rolling average, various projections and the like, including post processed results according to Gaussian or non-Gaussian distributions or standard deviations and so on.

In various embodiments a rolling average of CDs is used such as an average of a finite number of previously identified unambiguous event pairs (e.g., 10, 20 100 or more), or a finite time period within which unambiguous event pairs have been identified (e.g., 1 minute, 10 minutes, 30 minutes, one hour and so on).

In various embodiments, a weighted average of CDs is used such as providing a greater weight to more recently identified unambiguous event pairs and/or giving different statistical weight to different types of event pairs based upon type of event of interest (e.g., fault events weighted more or less than recovery events) or other criteria.

The various steps described above with respect to the method 400 of FIG. 4 depicts an exemplary mechanism by which a DCWA 229 opportunistically adapts or updates correlation distance, correlation window and/or other information suitable for use by the CPAM 228. In this manner, the function of the CPAM 228 is improved over time by dynamically updating CD and CW information.

It is noted that the various steps performed by the CPAM 228 (FIG. 3) and DCWA 229 (FIG. 4) are performed in a substantially independent manner. That is, DCWA 229 operates to opportunistically update CW and/or CD information in response to event occurrences, while the CPAM 228 operates to respond to event correlation requests as they are received. The CPAM 228 and DCWA 229 are functionally independent, though they may be implemented within the same module or entity.

The various embodiments operate to reduce the problem space, required resources and processing time associated with processing tenant inquiries relating to QoS problems, the VM failures/flapping, BGP failures and the like. In particular, the CW associated with the various VM/BGP correlation pairs adapts over time in response to network conditions. In this manner, diagnostic correlations in response to tenant inquiries and the like are handled as expeditiously as possible and without user input.

As an example, assume that a particular virtual machine was unreachable or flapping on and off (i.e., working and not working) at particular times. The tenant (or DC operator) associated with the VM provides to the data center operator the IP address of the virtual machine and the particular time at which VM performance was poor or failed. With this information, event data associated with the VM may be extracted from the VM event log and quickly correlated to BGP event data from the BGP event log.

In various embodiments, the correlation window or interval is tuned over time in response to VM/BGP events such that the resulting correlation of VM/BGP event data is improved in terms of speed as well as resource utilization, thereby providing rapid debugging of the poorly performing (or apparently poorly performing) VM operation.

In one embodiment, an initial or default CW is selected, such as ±10 seconds. As time progresses and VM or BGP events occur, the default CW is modified. Advantageously, the default CW converges relatively quickly to an optimal or updated CW for the data center. Moreover, by using this mechanism there is no need for manual or semi-automated “tuning” of the CW; the CW is maintained at a relatively optimal distance (i.e., the average CD) and size (i.e., the CD standard deviation).

Various embodiments provide, as a background operation independent of the correlation operation, a continuous recalculation of Correlation Distance and/or Correlation Window information which is used to satisfy on-demand event correlation requests. Recalculation samples include un-ambiguous pairs of events only (others are dropped out of calculations) to improve precision.

It should be noted that the invention also has more general applicability to any type of correlation of occurring event pairs. Thus, while described within the context of correlating VM/BGP event pairs, other types of event pairs within the context of network management, data center management and other endeavors may also benefit from the various embodiments.

FIG. 5 depicts a high-level block diagram of a computing device such as a used in a telecom or data center network element or management system, suitable for use in performing functions described herein. Specifically, the computing device 500 described herein is well adapted for implementing the various functions described above with respect to the various data center (DC) elements, network elements, nodes, routers, management entities and the like, as well as the methods/mechanisms described with respect to the various figures.

As depicted in FIG. 5, computing device 500 includes a processor element 503 (e.g., a central processing unit (CPU) and/or other suitable processor(s)), a memory 504 (e.g., random access memory (RAM), read only memory (ROM), and the like), a cooperating module/process 505, and various input/output devices 506 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 505 can be loaded into memory 504 and executed by processor 503 to implement the functions as discussed herein. Thus, cooperating process 505 (including associated data structures) can be stored on a computer readable storage medium, e.g., RAM memory, magnetic or optical drive or diskette, and the like.

It will be appreciated that computing device 500 depicted in FIG. 5 provides a general architecture and functionality suitable for implementing functional elements described herein or portions of the functional elements described herein.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, transmitted via a tangible or intangible data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for correlating events, comprising:
in response to an event correlation request indicative of an event of interest, examining event log information within a correlation window (CW) to identify one or more events correlated with said event of interest; and
in response to an occurrence of an unambiguous event pair, updating said CW using correlation distance (CD) information associated with said unambiguous event pair.

2. The method of claim 1, wherein said event of interest comprises a virtual machine (VM) event within a data center (DC), and said one or more events correlated with said event of interest comprise Border Gateway Protocol (BGP) events.

3. The method of claim 1, wherein said event of interest comprises a Border Gateway Protocol (BGP) within a data center (DC), and said one or more events correlated with said event of interest comprise virtual machine (VM) events.

4. The method of claim 1, wherein said CW is defined as an Average CD±one CD Standard Deviation.

5. The method of claim 2, wherein said CW is defined as
+Average CD±one CD Standard Deviation.

6. The method of claim 3, wherein said CW is defined as
−Average CD±one CD Standard Deviation.

7. The method of claim 1, wherein said occurrence of an unambiguous event pair is determined by:
detecting an event of interest;
examining event log portions associated with a selected timer interval to identify therein any candidate root events; and
in the case of a single candidate root event, selecting the single candidate root event as being correlated with the event of interest to provide thereby said unambiguous event pair.

8. The method of claim 7, wherein said timer interval comprises said CW.

9. The method of claim 7, wherein said timer interval comprises an Unambiguous Event Correlation Window (UECW) selected according to a type of event of interest.

10. The method of claim 9, wherein said type of event of interest comprises one of a failure event and a recovery event.

11. The method of claim 7, wherein said selected interval is increased in duration in response to a failure to find a candidate root event during said selected interval.

12. The method of claim 11, wherein said selected interval is decreased in duration in response to finding more than one candidate root event during said selected interval.

13. The method of claim 12, wherein said selected interval is increased or decreased by a fixed amount of time.

14. The method of claim 12, wherein said selected interval is increased or decreased by a fixed percentage of said selected interval.

15. The method of claim 7, wherein said event of interest comprises one or more of a BGP fault/failure event, a BGP fault/failure recovery event, a VM fault/failure event and a VM fault/failure recovery event.

16. The method of claim 5, wherein said Average CD comprises a rolling average of CDs for a plurality of unambiguous event pairs.

17. The method of claim 5, wherein said Average CD comprises a weighted average of CDs for a plurality of unambiguous event pairs, wherein more recent pairs are given a higher weight than less recent pairs.

18. An apparatus for correlating events, the apparatus comprising:
a processor configured for:
in response to an event correlation request indicative of an event of interest, examining event log information within a correlation window (CW) to identify one or more events correlated with said event of interest; and
in response to an occurrence of an unambiguous event pair, updating said CW using correlation distance (CD) information associated with said unambiguous event pair.

19. A tangible and non-transient computer readable storage medium storing instructions which, when executed by a computer, adapt the operation of the computer to perform a method for correlating events, the method comprising:
in response to an event correlation request indicative of a event of interest, examining event log information within a correlation window (CW) to identify one or more events correlated with said event of interest; and
in response to an occurrence of an unambiguous event pair, updating said CW using correlation distance (CD) information associated with said unambiguous event pair.

20. A computer program product wherein computer instructions, when executed by a processor in a network element, adapt the operation of the network element to provide a method for correlating events, the method comprising:
in response to an event correlation request indicative of an event of interest, examining event log information within a correlation window (CW) to identify one or more events correlated with said event of interest; and
in response to an occurrence of an unambiguous event pair, updating said CW using correlation distance (CD) information associated with said unambiguous event pair.
